(19) United States
(12) Patent Application Publication
(10) Pub. No.: US 2010/0243211 A1
(43) Pub. Date: Sep. 30, 2010

(54) HEAT DISSIPATING STRUCTURE OF HIGH POWER LED PROJECTOR LAMP

(76) Inventors: George Anthony. MEYER, IV, San Jose, CA (US); Chien-Hung Sun, Zhongli City (TW); Chieh-Ping Chen, Zhongli City (TW)

Correspondence Address: HDLS Patent & Trademark Services, P.O. BOX 220746, CHANTILLY, VA, 20153-0746, US

(21) Appl. No.: 12/409,682

(22) Filed: Mar. 24, 2009

(51) Int. Cl. F28D 15/00; H01J 7/24

(52) U.S. Cl. 165/104.26; 313/45

(57) ABSTRACT

A heat dissipating structure is capable of dissipating heat quickly in a high power LED projector lamp to improve the heat dissipating efficiency. The structure includes a heat-conducting plate, a plate type heat pipe and a plurality of heat dissipating fins. One side of the heat-conducting plate provides a plurality of grooves for mounting one end of the plate type heat pipe, wherein those two are perpendicular to each other. Furthermore, the heat dissipating fins having a plurality of slots are stacked and arranged at intervals for disposing the plate type heat pipe with an inclined angle. Hence, the heat generated from the high power LED will be conducted quickly and the heat dissipating efficiency will be improved.

### BACKGROUND OF THE INVENTION

1. Field of the Invention

The present invention generally relates to a heat sink, and more particularly to a heat dissipating structure disposed in a high power light emitting diode (LED) lamp.

2. Description of Prior Art

There are many projector lamps, which are applied as lighting devices in many places such as exhibitions, stores, etc., on the market.

The technology of light emitting diodes (LEDs) grows and becomes mature because of the features of low power consumption, long service life, small size and quick response. The LED lamps gradually substitute traditional light bulbs and are extensively used in various lighting devices. However, high power of the LEDs brings the problem of heat dissipation. It needs to be considered about the heat dissipating structure of the high power LEDs applied in the projector lamps.

With reference to FIG. 1, an LED projector lamp 1a has a metal housing 2a, wherein a high power LED (not shown) is disposed inside the metal housing 2a. A metal panel 3a is set in the front of the LED projector lamp 1a, and a reflecting cover 4a is positioned thereon. The light is emitted from the high power LED by the reflecting cover 4a. The heat dissipating manner is to arrange many parallel heat dissipating fins on the outer surface of the metal housing 2a to enlarge the heat dissipating area for increasing the heat dissipation efficiency. Nevertheless, most of the LED projector lamps are provided with many heat dissipating fins, which will occupy a large space. On the other side, another solution is to set a fan in the projector lamp to blow away the high heat of the LEDs by forced convection. However, it requires consuming extra electricity when the fan is operating, which contradicts the conception of power saving and environment protecting.

### SUMMARY OF THE INVENTION

It is a primary object of the invention to provide a heat dissipating structure of a high power LED projector lamp, which can effectively dissipate the heat of a high power LED to improve the heat dissipating efficiency without an additional fan.

Another object of the invention is to provide a heat dissipating structure of a high power LED projector lamp, which can reduce the size of the LED projector lamp.

To achieve the foregoing objects, the present invention provides a heat dissipating structure of a high power LED projector lamp comprising a heat-conducting plate, a plate type heat pipe and a plurality of heat dissipating fins. One side of the heat-conducting plate is provided with a plurality of grooves for being embedded by one end of the plate type heat pipe, where those two are perpendicular to one another. Furthermore, the heat dissipating fins are stacked with an inclined angle and parallelly arranged with gaps, in which the heat dissipating fins have a plurality of slots for accommodating the plate type heat pipe. Hence, the heat generated from the high power LEDs can be conducted quickly and the heat conduction efficiency will be improved.

In comparison with the conventional LED projector lamp, the present invention can promote the heated air within the gaps to rise by disposing the slant heat dissipating fins on both sides of the plate type heat pipe. It can not only rapidly conduct the heat generated from the high power LED but also improve heat conduction efficiency of the heat dissipating fins. Moreover, the integrated exterior size and its occupying space can be reduced because the heat dissipating fins are aslant stacked at intervals. Because the heat dissipating structure of the present invention has the plate type heat pipe conducting heat rapidly and the heat dissipating fins having large heat-dissipating areas, it can dissipate the heat of high power LEDs by natural convection without consuming any electricity.

### BRIEF DESCRIPTION OF DRAWINGS

FIG. 1 shows a conventional LED projector lamp;

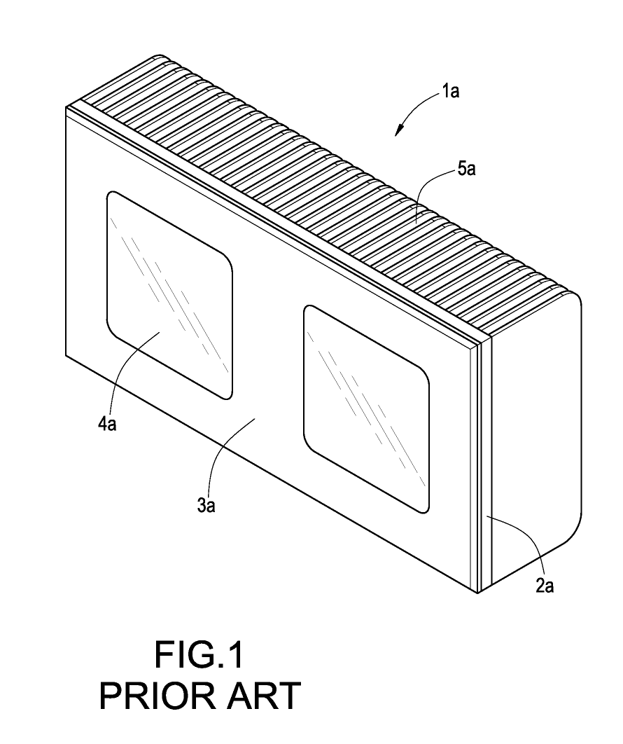

FIG. 2 is a perspective view of the heat dissipating structure of the present invention;

FIG. 3 is an exploded view of the heat dissipating structure of the present invention;

FIG. 4 shows the present invention applied in a lighting module;

FIG. 5 is a sectional view taken along line A-A′ of the FIG. 4; and

FIG. 6 is a schematic view showing the operating state of the present invention.

### DETAILED DESCRIPTION OF THE INVENTION

The technical characteristics, features and advantages of the present invention will become apparent in the following detailed description of preferred embodiments with reference to the accompanied drawings, and the preferred embodiments are used for illustrating the present invention only, but not intended to limit the scope of the present invention.

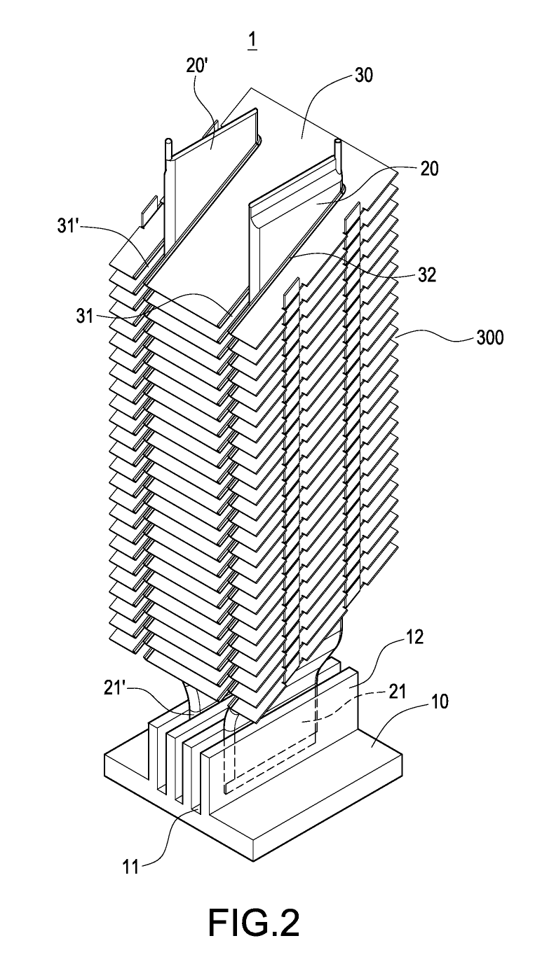

Referring to FIG. 2, the heat dissipation structure 1 comprises a heat-conducting plate 10, two plate type heat pipes 20, 20′ and a plurality of heat dissipating fins 30. The heat-conducting plate 10 is made of metal with good thermo-conductivity, such as copper or silver. One side of the heat-conducting plate 10 is provided with a plurality of grooves 11 for being embedded one end of the plate type heat pipes 20, 20′, and each of the grooves 11 is formed between two side plates 12.

The plate type heat pipes 20, 20′ are of a barlike shape. One end of each of the plate type heat pipes 20, 20′ is embedded in one of the grooves 11, and they are perpendicular to the heat-conducting plate 10. Each plate type heat pipe 20, 20′ has a bent section 21, 21′ on the side near the heat-conducting plate 10, which are sandwiched between the two side plates 12 for increasing the contacting area between the heat-conducting plate 10 and the plate type heat pipes 20, 20′. In the present invention, the bent directions of the bent sections 21, 21′ are in directions of approaching to each other for shorting the distance between two plate type heat pipes 20, 20′ in the side near the heat-conducting plate 10 and enlarging the distance in the other side. The heat dissipating fins 30 are stacked with a gap 300 between two adjacent fins. The heat dissipating fin 30 is provided with two slots 31 for accommodating the plate type heat pipes 20, 20′. A flange 32 on the edge of the slot 31 contacts the plate type heat pipes 20, 20′ for increasing the contact area between the heat dissipating fin 30 and the plate type heat pipes 20, 20′. The heat dissipating fins 30 are arranged with an inclined angle against the plate type heat pipes 20, 20′, in which the inclined angle is preferredly within a range from 25 degrees to 35 degrees. That is, the heat dissipating fins 30 are aslant disposed on the plate type heat pipes 20, 20′ with an angle about 25 degrees to 35 degrees. In the shown embodiment, two slots 31, 31′ corresponding to those two plate type heat pipes 20, 20′ are provided on the heat dissipating fin 30. In fact, the number of the slots 31 in the heat dissipating fin 30 and that of the plate type heat pipes 20, 20′ can be changed correspondingly. For example, the number of the slot 31 and that of plate type heat pipes 20, 20′ also can be one or three.

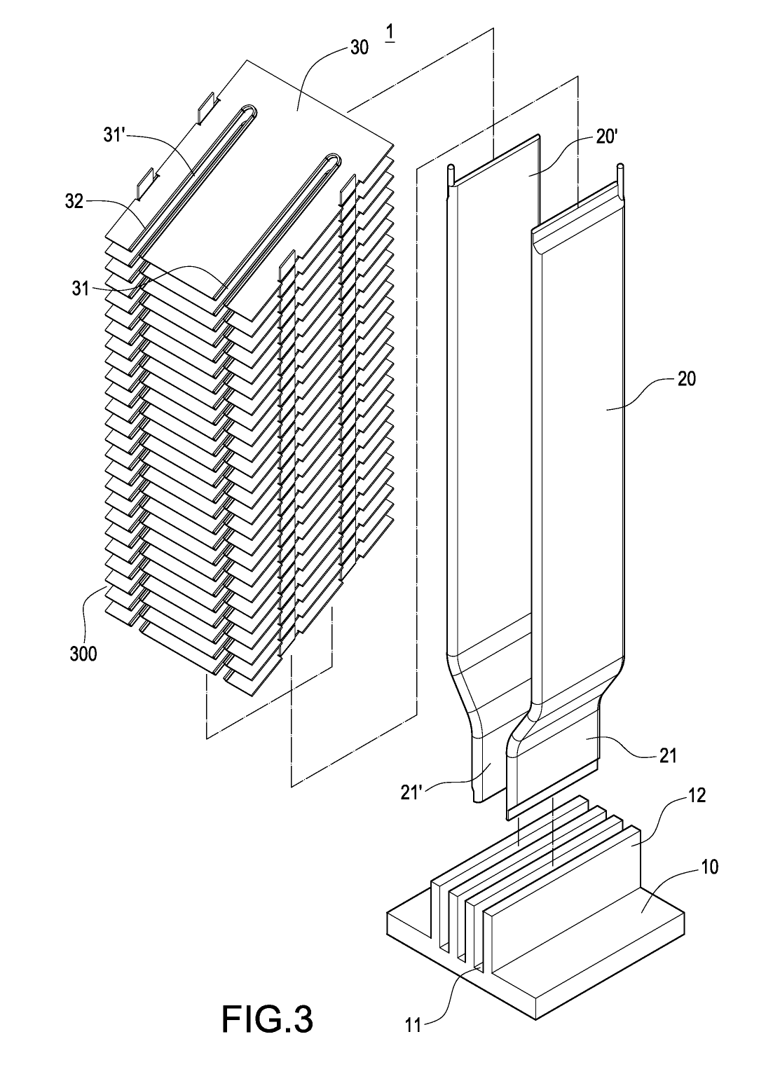

Please refer to FIG. 3, the heat dissipating fins 30 are arranged with an inclined angle. By aligning the slots 31, 31′ of the heat dissipating fins 30 with the heat pipes 20, 20′, the heat dissipating fins 30 can be aslant disposed. Last, the ends of the plate type heat pipes 20, 20′ are perpendicularly embedded in the grooves 11 of the heat-conducting plate 10, and the side plates 12 connect with the plate type heat pipes 20, 20′. Thus the assembly of the present invention is completed.

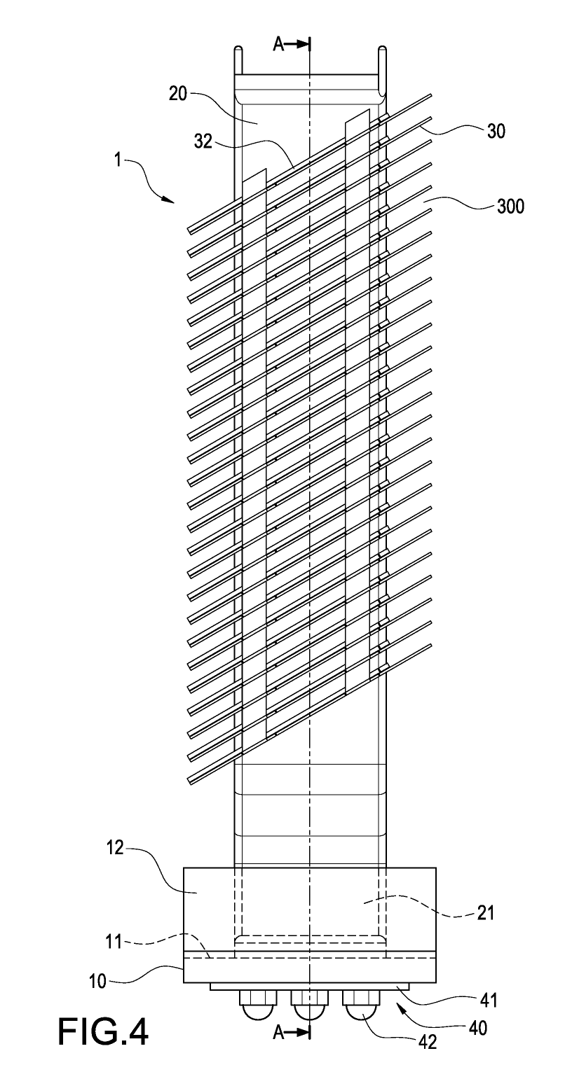

Referring to FIG. 4, the heat dissipating structure 1 is applied in a lighting module 40 of a high power LED projector lamp. The light module 40 is composed of a substrate 41 and a plurality of LEDs 42 electrically connected thereto. The plate type heat pipes 20, 20′ and the heat dissipating fins 30 disposed thereon are arranged on one side of the heat-conducting plate 10, whose the other side connects with the substrate 41. The heat dissipating structure 1 will dissipate the heat generated from the light module 40.

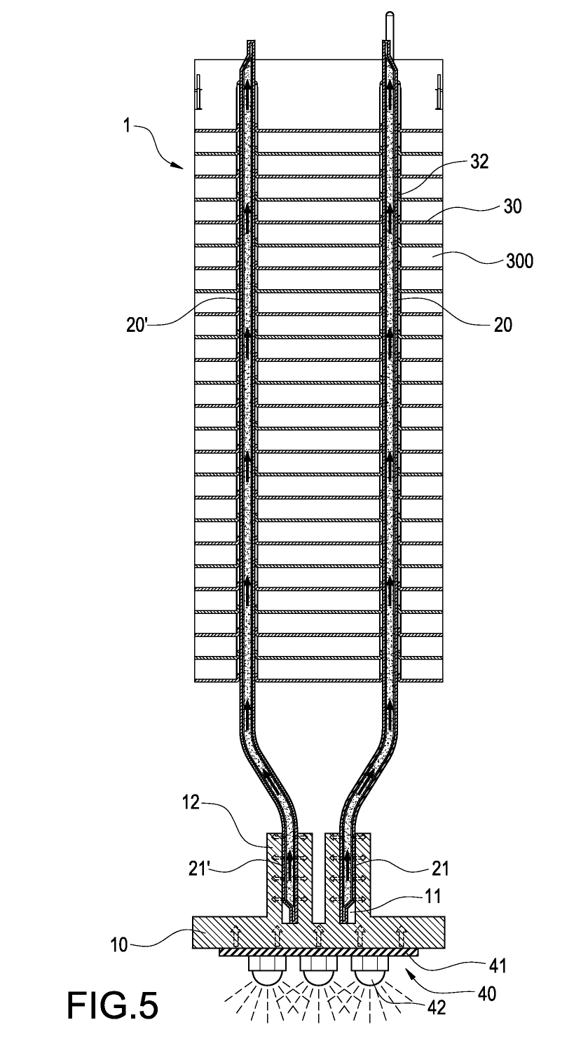

Please further refer to FIG. 5, the heat generated from the LEDs 42 will be conducted to the heat-conducting plate 10, and then the heat-conducting plate 10 will transfer most of the heat to the plate type heat pipes 20, 20′. Next, the heat will be conducted to the heat dissipating fins 30 by the flange 32 contacting with the plate type heat pipes 20, 20′. Finally, the heat will be dissipated rapidly through the heat dissipating fins 30.

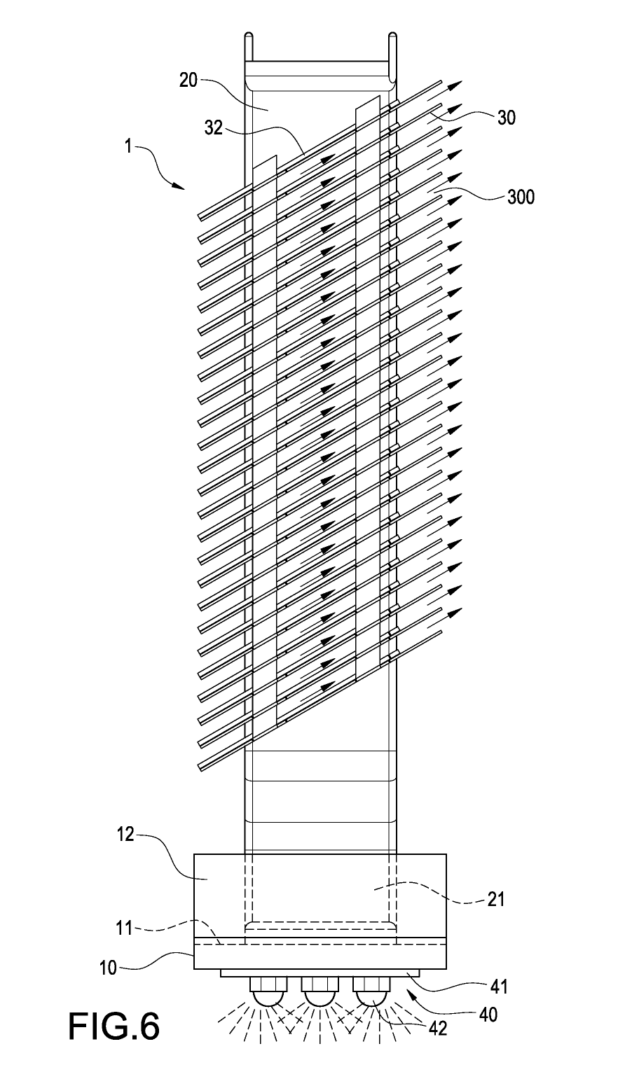

Please refer to FIG. 6, the heat conducted to the heat dissipating fins 30 is dissipated by natural convection. Therefore, the slant heat dissipating fins 30 disposed on the plate type heat pipes 20, 20′ can promote the heated air within the gaps 300 to rise. It can enhance the heat dissipation of the heat dissipating fins 30 for improving the heat dissipating efficiency of the heat dissipating structure 1.

While the invention is described in by way of examples and in terms of preferred embodiment, it is to be understood that the invention is not limited thereto. On the contrary, the aim is to cover all modifications, alternatives and equivalents falling within the spirit and scope of the invention as defined by the appended claims.

What is claimed is:

1. A heat dissipating structure for a high power LED projector lamp comprising:
a heat-conducting plate having at least one groove on one side thereof; at least one plate type heat pipe, whose one end is perpendicularly embedded in the at least one groove; and
a plurality of heat dissipating fins fixed on the at least one plate type heat pipe, each of the heat dissipating fins having a slot for accommodating the at least one plate type heat pipe, wherein the heat dissipating fins incline against the at least one plate type heat pipe by an inclined angle.

2. The heat dissipating structure of claim 1, further comprising another one plate type heat pipe, and each of the two plate type heat pipes having a bent section on an end near the heat-conducting plate, and the bent directions of the two bent sections are approaching to each other.

3. The heat dissipating structure of claim 1, wherein the at least one groove is formed by two side plates.

4. The heat dissipating structure of claim 1, wherein each of the heat dissipating fins has a flange on an edge of the slot for contacting the plate type heat pipe.

5. The heat dissipating structure of claim 1, wherein the inclined angle is within a range from 25 degrees to 35 degrees.
